(19) United States
(12) Patent Application Publication
(10) Pub. No.: US 2020/0302553 A1
(43) Pub. Date: Sep. 24, 2020

(54) SYSTEMS AND METHODS FOR SELECTIVITY IN MATCHING COUPLES

(71) Applicant: Rachel Abramowitz, New York, NY (US)

(72) Inventor: Rachel Abramowitz, New York, NY (US)

(21) Appl. No.: 16/429,765

(22) Filed: Jun. 3, 2019

Related U.S. Application Data
(63) Continuation of application No. 15/957,688, filed on Apr. 19, 2018, now abandoned.

(51) Int. Cl. G06Q 50/00; G08B 5/38; H04W 76/10

(52) U.S. Cl. CPC G06Q 50/01; H04W 76/10; G08B 5/38

(57) ABSTRACT

A system and method for deriving personal information to be used in the matching of persons seeking to be matched for social activities is described herein. The system and method provides at least one scoring of information derived from at least one user based on inputted information in response to imagery provided to the user.

### PRIORITY

This application claims priority to U.S. Provisional Application 62/487,173, filed Apr. 19, 2017, which is hereby incorporated by reference.

### FIELD OF THE INVENTION

The present invention relates generally to the field of dating applications, and, more specifically, to a system and method for selectivity in matching couples.

### BACKGROUND

The rise of social media connects and the proliferation of portable terminals (e.g., notebook computers, cellular telephones, personal data assistants (PDAs), smartphones and other similar communication devices), have created a high degree of connectivity available via the Internet to chat, socialize and communicate with friends, family, and other third parties. This interconnectedness has given rise to the field of Internet dating and other social interaction services generally. Such “online dating” allows people to meet and get acquainted online thereafter potentially engaging in a romantic relationship. Conventional dating services are oftentimes moderated by a third party who matches candidates based upon criteria and/or preferences (e.g., profile data).

These traditional online dating services allow a user to create a profile generally containing information relating to physical as well as personal characteristics. Such traditional online dating services also allow users to search profiles of other candidates in order to locate a match based upon a predetermined set of criterion, such as, for example physical characteristics such as age, height, weight, hair color, and the like, as well as personal characteristics, such as income, interests, hobbies, religion, and the like, may be used to search profiles.

However, these online dating services limit the ability of people to successfully meet online and possibly develop a friendship, a romantic or even sexual relationship. Similarly, such systems also allow for people to misrepresent themselves, such as being untruthful about their marital and/or relationship status, age, gender, physical attributes or even their socio-economic status. The mere post of a profile makes it easy for a user to be untruthful about individual criteria as well as to post a photo that is not current or even a photo that is not really that of the individual.

Thus, there exists a need to provide an online dating system which may limit the amount of false or misleading information and that may more acutely pair potential couples together based on more than just user entered information.

### BRIEF SUMMARY OF THE INVENTION

The present invention provides a system and method for deriving personal information to be used in the matching of persons seeking to be matched for social activities is described herein. The system and method provides at least one scoring of information derived from at least one user based on inputted information in response to imagery provided to the user.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 illustrates a computer system for providing user interaction and communications under one exemplary embodiment;

FIG. 2 illustrates a computer system for providing user interaction and communications under one exemplary embodiment;

FIG. 3 illustrates an exemplary wireless device structure for providing user interaction and communications under one exemplary embodiment;

FIG. 4 illustrates imagery used in an embodiment of the present invention;

FIG. 5 illustrates comparative imagery used in an embodiment of the present invention;

FIG. 6 illustrates a portion of a graphical user interface used in an embodiment of the present invention;

FIG. 7 illustrates a portion of a graphical user interface used in an embodiment of the present invention; and

FIG. 8 illustrates a portion of a graphical user interface used in an embodiment of the present invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

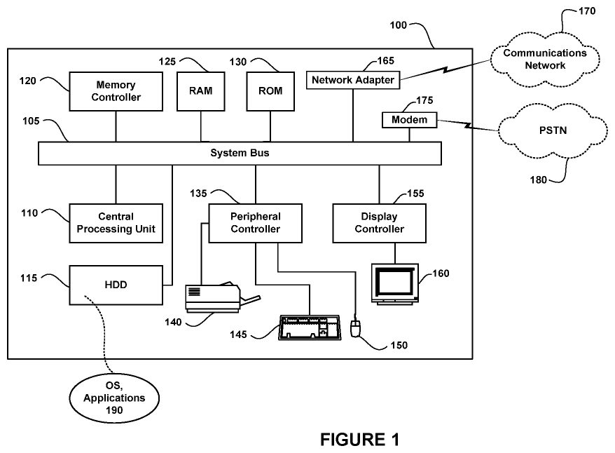

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, instant messaging, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

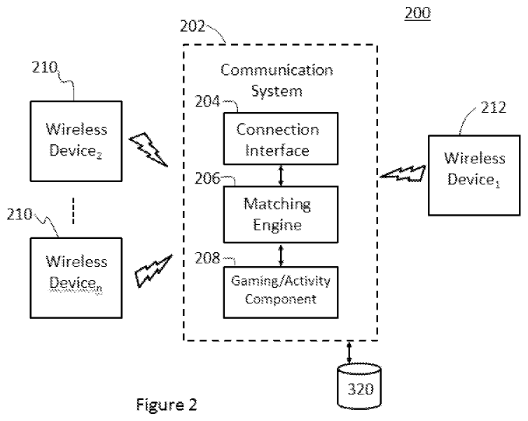

As shown in FIG. 2, computing system 100 may be deployed in networked computing environment 200. As illustrated in FIG. 2, the present invention provides system 200 that enhances traditional social networking systems by providing various gamification and matching between two people not by how attributes correspond to each other, but how two people interpret/perform/arrive at the same data from an outside input to enhance connecting individual. Games and activities can particularly add to the basic review of a profile. Rather than a user merely searching profiles of potential candidates, the games and activities within the social networking environment may provide for real-life and impromptu information to be revealed. Thus, users may be provided with additional information above and beyond that of a prepared profile when making connection decisions.

In an embodiment of the present invention, system 200 enables users to engage in gaming (or other social activities) by way of anonymous communication. While many of the aspects described herein are directed toward anonymous communication in the gaming environment(s), it is to be understood that the anonymous communication feature is optional and that other aspects exist wherein identities are revealed. These alternative aspects are to be included within the scope of this disclosure and claims appended hereto.

In an embodiment of the present invention, the system 200 can facilitate social interaction games that include communication via voice, video, text, picture messaging, or any combinations thereof. Embodiments may include games or activities without voice, with voice, with video, without video, with images, without images, with only text, for example. More specifically, multi-player games, such as Words with Friends®, Word Streak with Friends®, Tic-Tac-Toe, and Yahtzee®, for example, may be played between user of the system and include intra-player communications supported by the present invention. Although players of the games may be matched together based on traditional criteria and inputted user attributes, it will be understood that users may further define more narrow subgroups of users for a particular game. For example, a user may opt to only play with candidates from the same city, state, zip code, for example, to interact with someone reasonably proximate to themselves.

In operation, the system 200 illustrated in FIG. 2 may facilitate suspension of a game or activity application upon commencement of a communication session. Accordingly, upon termination of the communication session, system 200 may restore the application based upon the state of the service (e.g., game, activity) at the time of suspension. In operation, the state can be transferred to the communication system thus enabling a user the ability to continue to interact with the system or other users within the activity environment. Similarly, game play may continue with the communication session being semi-continuous as between at least two participants and may be provided as an overlay to the game play.

In an embodiment of the present invention, system 200 may include a communication system component 202 that may facilitate the gaming, activities, anonymous communication and service suspension functionality of the innovation. As shown, the communication system component 202 may include a connection interface component 204, a matching engine 206, and a gaming/activity component 208. The functionality of each of these components will be described in greater detail with respect to the figures that follow.

As illustrated in FIG. 2, the communication system component 202 can be employed to facilitate communications between wireless devices (212, 210). By way of particular example, the communication system component 202 may be employed to connect parties in a chat room environment where anonymity is desired.

Referring again to the subcomponents (204, 206, and 208) of the communication system component 202, the connection interface component 204 may manage details with respect to a desired communication. For instance, the connection interface 204 may be employed to identify the parties, schedule or connect the communication session, suspend and/or restore a social service, etc. More particularly, as shown in the figures that follow, the connection interface 204 may include the service that effectuates locating and selecting a party (e.g., candidate) for which to connect utilizing, in part, matching engine 206.

In operation, the connection interface component 204 interacts with the matching engine 206 and the gaming/activity component 208 in order to trigger the desired communication session. As described herein, this communication session may be a voice communication session, a video communication session, a picture-based session, a text messaging communication session or any combination thereof. It will be understood by those skilled in the art that it is a feature of the present invention to enable two (or more) parties to agree to communicate thereafter being connected via the communication system component 202.

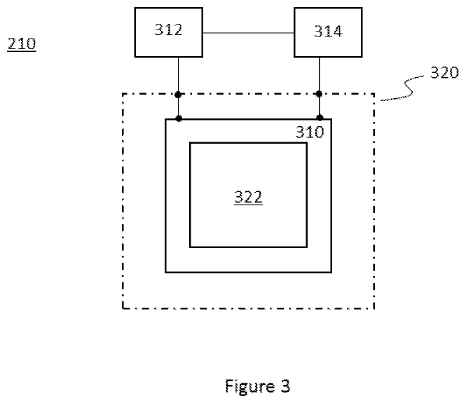

In an embodiment of the present invention, as illustrated in FIG. 3, wireless device 210 may comprise at least one non-transitory memory 312 and at least one manager 314, communicatively couple to at least one display 320. As would be appreciated by those skilled in the art, display 320 may provide the user with any GUI, app, or other visual content associated with the wireless device 210. For example, an app may be at least partially resident in non-transitory memory 312 and may, through at least partial control of the manager 314, provide at least one visual indicia to the user through display 320.

In an embodiment of the present invention, an app embodying at least a portion of the present invention may be remotely resident in non-transitory memory 312. The app may be in communication with communication system component 202 and may, for example, provide interface 310 within display 320. Interface 310 may take any visual form and may be provided as an overlay on content 322 of display 320. Interface 310 may be visually minimized relevant to content 322 and may expand visually in size as compared to content 322 when, for example, the user is interacting with interface 310 and/or an alert or other content is being delivered to display 320. Alerts and/or content may originate at least partially from communications system component 202 and may be indicative of information flow from and between matching engine 206 and/or gaming/activity component 208.

This flow of information may allow for targeted information and communications to flow between at least ones of a plurality of wireless devices to at least one interface 320. For example, a user may be viewing content 322 while an interface 310 in the form of a small thumbnail is resident with the display 320 overtop of content 322. The nature of content 322 (which may be determined by header information, for example) may be communicated to gaming/activity component 208, by manager 314, for example, which may, in turn, provide information to interface 320 indicative of at least one other user identified through the matching engine 206. The identification of the at least one user by the matching engine 206 may be at least partially weighted on the nature of content 322.

For example, a user who is viewing The New York Times® (whether through an app or web portal), for example, may be presented or have access to other users of the present invention who are or have read the same publication. In an embodiment of the present invention, the real time communications may occur between users of the present invention based on common content. Continuing with the example above, a user who is viewing The New York Times® may be alerted to or provided an indication that at least one other user who is simultaneously viewing The New York Times®. Moreover, the simultaneous viewing may be limited to specific articles within The New York Times®, for example. In either case, the connecting of at least two users viewing common content my allow for the facilitation of conversation around at least a portion of the content.

Indeed, a first user reading a particular article may actively engage with interface 310 and begin communicating with a user who has been identified by matching engine 206 as currently reading the same article, for example. The user may communicate through known means, such as through instant messaging, for example, which may or may not be facilitated through the present system, or the user may make initial contact by clicking on a comment or question provided by, for example, connection interface 204.

For example, if the commonly read article is related to touring the south of France, the present invention may, based on the content 322, provide automated questions, such as, for example, “Do you like to travel?” Although the user can provide and pose their own query, the automated question, which may be selected and sent in a single action, may allow for the sender to query a number of suggested users in a quick and efficient manner that raises the probability that an answer will be returned to at least one question posed while causing limited interruption in the user's enjoyment of content 322.

The alter or notification to a user through the interface 310 may take any form known to those skilled in the art and may cause the user to expand access to the interface 320 and/or access the app natively to more fully interact with communication system component 202. For example, a user may be playing a card game such as solitaire, for example, and may be given a notification that a “match” has been made with a user on the network by a red flashing border around the content, a momentary visual flag, an auditory or tactile alert, and/or like combinations thereof. A user may or may not choose to interact with a proposed match, and may, for example, query the present invention for a match or near-match that may not automatically be brought to the user's attention.

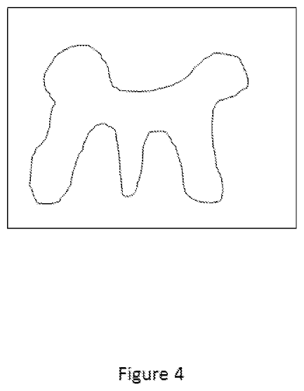

As discussed herein, matching engine 206 may utilize information other than that traditionally provided by a user of the system. For example, as illustrated in FIG. 4, a user may be presented with a visual image and asked to provide input regarding the image through at least one GUI associated with the present invention which may, for example, be provided through server 220. The image may be ambiguous and may be in the form of a inkblot, for example, and may be an artistic rendering of reality, and/or a photograph or like rendering, for example.

The input received from a user may be in the form of a recorded communication, such as a voice and/or video response, or as a selected input. For example, the GUI may provide for a selective input associated with each of the ones of presented images and allow the user to rate the image and/or choose a selected response. Rating may take many forms and may be scaled. For example, an image of kittens may be rated from 1 to 5, with 5 being more pleasing than 1. Similarly, an image conveying a sexual tone may be rated as “offensive” or “not offensive” and/or on a “like” scale to measure interest of the user. Scaled rating and binary choices may be applied to images presented and may be processed by the matching engine to enhance to matching of users.

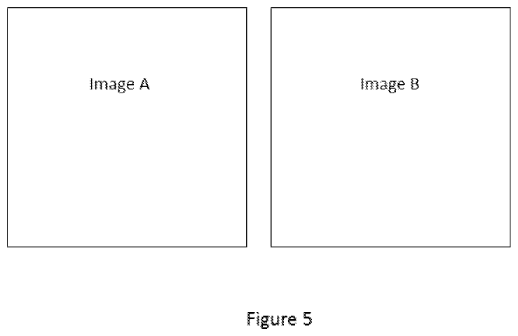

As illustrated in FIG. 5, the present invention may also present side-by-side images which may be different in a very limited way inducing a user to identify the difference between the photos. The images may be of any medium, and may include sexual overtones. For example, the primary nature of the image may include a partially clad woman in a sexually suggestive position in a lounge setting wherein the difference between the images may be the absence of a wall hanging in the background of one of the otherwise identical images. A user may be measured on the time it takes to find the difference, the number of times the image is hovered by a cursor, the number of times the images is viewed, and like measurable attributes of user interaction. Such images may also be presented commensurate with input by the user signifying the tolerance or threshold of the user for provocative imagery.

Taking in all information derived from user inputs and other system interactions, the matching engine 206 may use variations of known processes, such as FICO™ and TRIAD™ scoring to quantify aspects of user inputs which may include, not only inputs related to presented media, but also user game selection, game success and usage, for example. Similarly, the matching engine 206 may use game theory to match two users by how those users interpret/perform/arrive at the same data from outside input. For example, n-person games may be used to analyze a population of users, where the frequency with which a particular decision is made may change over time in response to the decisions made by all individuals in the population. Such a theory may capture changes over time as users play one of the offered game or provide in to the same image(s) multiple times within a given period of time, and consciously (and perhaps rationally) provide varying input.

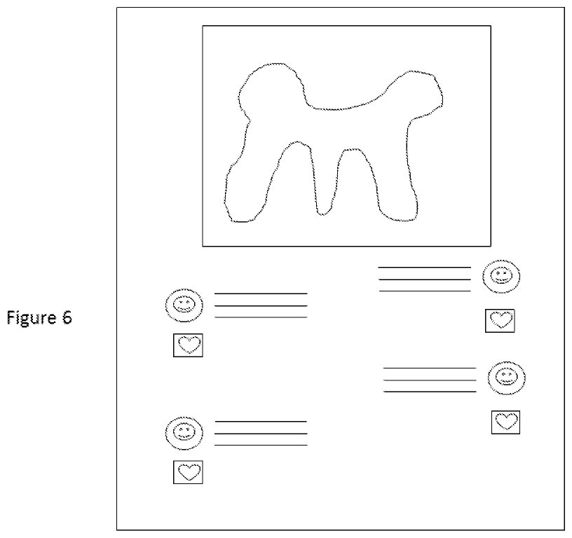

As discussed above and illustrated in FIG. 6, a presented image, such as an inkblot, for example, may be commented on by at least one user and may, preferably, provide a forum as between at least two users. Alone or in combination with an additional user, user input may be collected continuously and used with the matching engine and overall system described herein to provide for a more successful match between two individuals. Each user may provide discrete input, may indicate favor in the content (by clicking the “heart” icon, for example, and/or by selecting a particular prepopulated input provided in conjunction with the particular image.

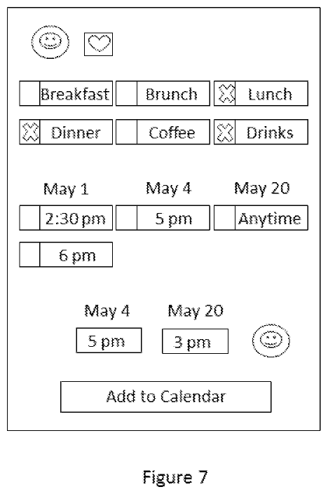

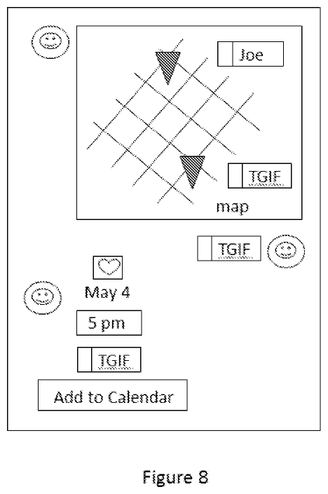

Individuals matched by the present invention may be presented with an opportunity to meet. As illustrated in FIG. 7, the GUI may provide options to users such as the type of meeting and the time to meet. Although presented here as a single offering, the information shown in FIG. 6 may be presented in a stepwise fashion and/or through distinct GUI presentations. A first user, for example, may indicate that they are willing to meet for a variety of events, such as lunch, dinner or drinks. The user may also provide one or more dates and times for their availability. A second user may offer back one or more times and/or select a specific time as the preference and subsequently calendar the meeting. As would be appreciated by those skilled in the art, a calendar reminder may be sent to each user at an address designated by the user in the system. In accordance with privacy provisions which may be engaged in the system, users may communicate through the system and share direct contact information only affirmatively to one another as desired. To facilitate the meeting more efficiently, the present invention may also provide each user with location information as illustrated in FIG. 8.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A system for facilitating social interaction between at least two users, comprising:
a first manager resident in a non-transitory memory of a first mobile device for monitoring displayed content on a display of the first mobile device;
a second manager resident in a non-transitory memory of a second mobile device for monitoring displayed content on a display of the second mobile device;
a matching engine, remote from the first and second mobile devices, for matching a user of the first mobile device with a user of the second mobile device based on a similarity between displayed content of the first mobile device and displayed content of the second mobile device.

2. The system of claim 1, in response to the matching, establish a communication session between the first and second user.

3. The system of claim 2, prior to establishing the communication session, generating an alert on at least one of the first and second mobile devices.

4. The system of claim 3, the alert comprises a flashing border around the displayed content.

5. The system of claim 1, wherein the similarity is based at least in part on a weight on the nature of the displayed content on the respective devices.

6. The system of claim 1, wherein the similarity is based at least in part on a rating provided by the first and second users.

7. The system of claim 1, wherein the similarity is based at least in part on discrete input provided by the first and second users.

8. A method for facilitating social interaction between at least two users, the method comprising:
monitoring, by a first manager resident in a non-transitory memory of a first mobile device, for displayed content on a display of the first mobile device;
monitoring, by a second manager resident in a non-transitory memory of a second mobile device, monitoring displayed content on a display of the second mobile device;
matching, by a matching engine, remote from the first and second mobile devices, for a user of the first mobile device with a user of the second mobile device based on a similarity between displayed content of the first mobile device and displayed content of the second mobile device.

9. The method of claim 8, in response to the matching, establishing a communication session between the first and second user.

10. The method of claim 9, prior to establishing the communication session, generating an alert on at least one of the first and second mobile devices.

11. The method of claim 10, the alert comprises a flashing border around the displayed content.

12. The method of claim 8, wherein the similarity is based at least in part on a weight on the nature of the displayed content on the respective devices.

13. The method of claim 8, wherein the similarity is based at least in part on a rating provided by the first and second users.

14. The method of claim 8, wherein the similarity is based at least in part on discrete input provided by the first and second users.

15. A non-transitory computer-readable medium comprising instructions that when executed by a processor implement a method for facilitating social interaction between at least two users, the method comprising:
monitoring, by a first manager resident in a non-transitory memory of a first mobile device, for displayed content on a display of the first mobile device;
monitoring, by a second manager resident in a non-transitory memory of a second mobile device, for displayed content on a display of the second mobile device;
matching, by a matching engine, remote from the first and second mobile devices, for a user of the first mobile device with a user of the second mobile device based on a similarity between displayed content of the first mobile device and displayed content of the second mobile device.

16. The medium of claim 15, in response to the matching, establishing a communication session between the first and second user.

17. The medium of claim 16, prior to establishing the communication session, generating an alert on at least one of the first and second mobile device.

18. The medium of claim 17, the alert comprises a flashing border around the displayed content.

19. The medium of claim 15, wherein the similarity is based at least in part on a weight on the nature of the displayed content on the respective devices.

20. The medium of claim 15, wherein the similarity is based at least in part on a rating provided by the first and second users.
